(19) United States
(12) Patent Application Publication
(10) Pub. No.: US 2024/0053654 A1
(43) Pub. Date: Feb. 15, 2024

(54) SHIELDING DEVICE AND ELECTRONIC APPARATUS USING THE SAME

(71) Applicant: Hunchun Ever Bright Electronic Technology Co., Ltd., Yanbian (CN)

(72) Inventors: Yungping Yang, Taoyuan (TW); Huawei Yang, Taoyuan (TW); Shouchun Li, Yanbian (CN); Simon Li, Yanbian (CN)

(21) Appl. No.: 18/111,572

(22) Filed: Feb. 19, 2023

(30) Foreign Application Priority Data
Aug. 12, 2022 (CN) 202210968050.3

(51) Int. Cl. G03B 11/04; H02K 11/215; H02K 41/035; G06F 1/16

(52) U.S. Cl. CPC G03B 11/043; H02K 11/215; H02K 41/0356; G06F 1/1605; H02K 2211/03

(57) ABSTRACT

A shielding device includes a shielding member, a magnet fixed to the shielding member, a support for supporting and allowing movement of the shielding member in a direction parallel to an X-axis, and a coil wound in a hollow cylindrical shape with a winding axis parallel to the X-axis. Herein, at least a portion of the magnet is inserted into an inner side of the coil. The shielding device controls the shielding member by leveraging magnetism, which is simple and damage-proof. An electric driving structure includes the coil wound in the hollow cylindrical shape and the magnet inserted into the inner side of the coil, which can be structured compactly and thus suitable for use in various electronic apparatuses such as ultra-thin displays, laptops, and desktop computers.

### CROSS-REFERENCE TO RELATED APPLICATION

The present application claims priority of China Patent Application No. 202210968050.3, filed on Aug. 12, 2022, which are incorporated herein by reference.

### BACKGROUND OF THE INVENTION

### 1. Technical Field

The present disclosure relates to a shielding device, and more particularly, to a shielding device and an electronic apparatus using the same.

### 2. Description of Related Art

With technological development, more electronic apparatuses, such as mobile phones, tablet computers, computers, televisions, displays, and video phones, are equipped with photographing devices. These electronic apparatuses are often loaded with a plurality of applications that can control the photographing device. Some applications or hackers may secretly turn on the photographing device without a user's knowledge, which is detrimental to the user's privacy. Therefore, it is desirable to equip the photographing device of the electronic apparatus with a shielding device.

In the prior art, solutions to the control of a lens shield of the photographing device by means of manual control can be found. For example, a novel sliding camera cover disclosed in the Chinese utility model patent No. CN201821243325.2 filed on Aug. 1, 2016, and published on Feb. 1, 2019, is a manual camera shielding device. When necessary, a user can manually slide a second plate to expose or shield the photographing device. This structure functions by means of the friction between the components, and poor engagement is likely to occur after long-term use, which results in short service life, not to mention the troublesome manual operation.

An automatically controlled lens shield of the photographing device is also available. A camera shielding structure and a mobile terminal disclosed in the Chinese utility model patent No. CN201721854347.8, filed on Dec. 25, 2017, and published on Jun. 29, 2018, is an example. This structure, however, is thicker in size, with which few electronic apparatuses are compatible.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is a perspective view of a shielding device according to a first embodiment.

FIG. 2 is an exploded view of the shielding device of FIG. 1.

FIG. 3 is a perspective view of a shielding member of the shielding device of the first embodiment.

FIG. 4 is a perspective view of a base of the shielding device according to the first embodiment.

FIG. 5 is a perspective view of a second fixing block of a locking assembly of FIG. 5.

FIG. 6 is a perspective view of a shielding device according to a second embodiment.

FIG. 7 is an exploded view of the shielding device of FIG. 6.

FIG. 8 is a perspective view of a shielding member of the shielding device of the second embodiment.

FIG. 9 is a schematic view showing the shielding member of the shielding device of the second embodiment in a shielded state, a protective cover being removed.

FIG. 10 is a schematic view showing the shielding member of the shielding device of the second embodiment in an exposed state, the protective cover being removed.

FIG. 11 is an exploded view of a shielding device of a third embodiment.

FIG. 12A is a front view of a laptop having a camera/photographing device with a shielding.

FIG. 12B is a perspective view of a desktop computer having a camera/photographing device with a shielding.

### DETAILED DESCRIPTION OF THE INVENTION

The invention will now be described in detail through several embodiments with reference to the accompanying drawings.

For the convenience of description, an X-Y-Z rectangular coordinate system is defined, and the shielding device of an electronic apparatus of the present disclosure is capable of moving in a direction parallel to an X-axis, and a direction toward a positive side of a Z-axis (+Z-axis side) is defined ahead/upward, and a direction toward a negative side of the Z-axis (−Z-axis side) is defined back/downward.

### First Embodiment

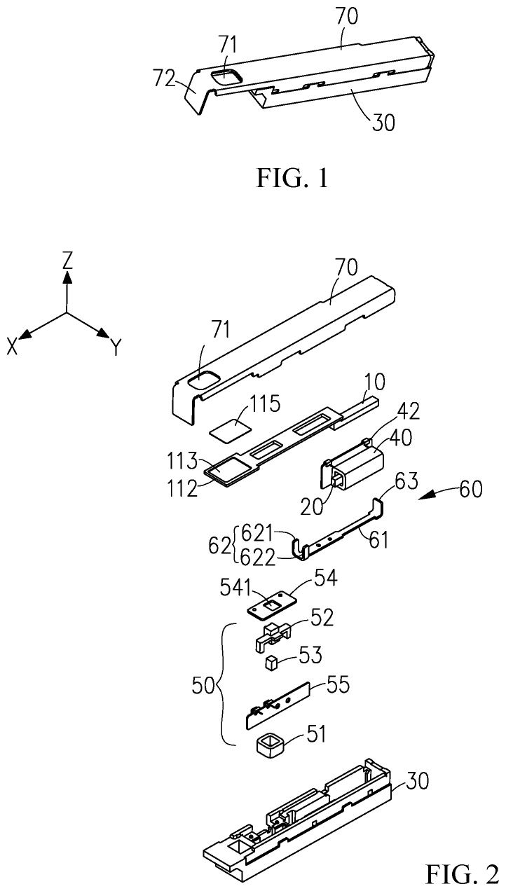

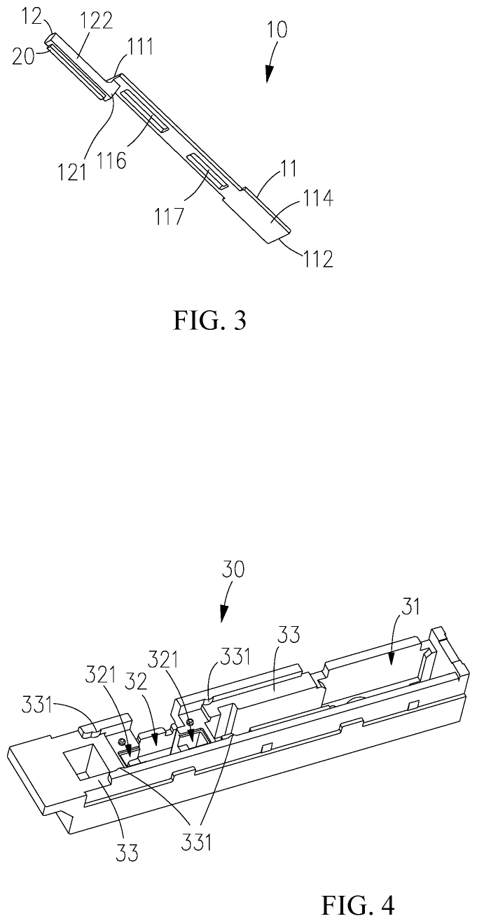

As shown in FIGS. 1 to 4, in a first embodiment, the shielding device of the present invention is applied to an electronic apparatus, such as a laptop as shown in FIG. 12A or a desktop computer as shown in FIG. 12B, for being disposed in front of a lens unit (such as the lens unit 200 in FIG. 12A or the lens unit 300 in FIG. 12B) of a photographing device/camera of the electronic apparatus so as to shield and expose the lens unit as needed. The shielding device mainly includes a shielding member 10, a magnet 20 fixed to the shielding member 10, a support 30 for supporting the shielding member 10, a coil 40 wound into a hollow cylinder, and a locking assembly 50.

Herein, the magnet 20 and the coil 40 constitute an electromagnetic driving unit of the shielding device, and at least a portion of the magnet 20 is inserted into an inner side of the coil 40 wound into a hollow cylinder. A winding axis of the coil 40 is parallel to the X-axis, and when the coil 40 is powered on, a magnetic field parallel to the X-axis is generated in the inner side of the coil 40 so that the magnet 20 is driven to move in a direction along the winding axis and the magnet 20 drives the shielding member 10 to move for shielding and exposing the lens unit of the photographing device. Specifically, when currents in opposite directions pass through the coil 40, respectively, to generate different magnetic fields that drive the magnet 20 to move in opposite directions along the winding axis (X-axis), respectively, thereby moving the shielding member 10. Since the magnet 20 is disposed on the inner side of the coil 40, the inner space of the coil 40 is utilized to the maximum, hence the size of the shielding device can be reduced, mainly the shielding device can be thinner. Furthermore, the magnetic field inside the coil 40 has the greatest magnetic force with less energy loss, and thus a coil of the same size can push a shielding member of greater mass. For accurate control, at least a portion of the magnet 20 should be on the inner side of the coil 40 when the magnet 20 is stopped at two limit positions or moved.

In this embodiment, the shielding member 10 includes a shielding sheet 11 and a fixing portion 12 connected to the shielding sheet 11, which are preferably made integrally of a light plastic material. Herein, the shielding sheet 11 is an elongated sheet, a plane where the shielding sheet 11 is located is parallel to a plane defined by the X-axis and a Y-axis; a length of the shielding sheet 11 is parallel to the X-axis, a first end (distal end) 111 thereof is connected to the fixing portion, and a second end 112 thereof is a free end. A portion close to the second end 112 serves as a light shielding portion 114 for shielding the lens unit of the photographing device when the shielding sheet 11 moves to a shielded position. A recess 113 is formed on a surface of the light shielding portion 114 facing the lens unit of the photographing device, and an opaque or semi-transparent film or sheet 115, which is a SOMA light shielding sheet in this embodiment, is fixed in the recess 113. It will be appreciated that in other embodiments, the opaque or semi-opaque film or sheet 115 may be omitted. In addition, in this embodiment, two spaced apart holes 116 and 117 are formed between the light shielding portion 114 and the first end 111 to act as snap-in locations. In particular, a width (dimension in the Y-axis direction) of the light shielding portion 114 is greater than a width of a portion from the light shielding portion 114 to the first end 111. Since the light shielding portion 114 is required to shield the lens unit, the width and length thereof shall be greater than a diameter of the lens unit, and the portion from the light shielding portion 114 to the first end 111 may be narrower, thus reducing the mass of the shielding member 10, which facilitates the movement thereof.

The fixing portion 12 includes a first portion 121 extending substantially perpendicularly from the first end 111 of the shielding sheet 11 and a second portion 122 extending from a distal end of the first portion 121 in a direction parallel to the X-axis, and the second portion 122 does not coincide with the shielding sheet 11 in the Z-axis direction or they coincide only at ends thereof. The first portion 121 is configured to position the second portion 122 lower than the shielding sheet 11 in the Z-axis so that the second portion can be inserted into the inner side of the coil 40 when an upper end face of the coil 40 is flush with or slightly lower or slightly higher than an upper surface of the shielding sheet 11, and thus a sum of heights of the shielding member 10 and the coil 40 as a whole in the Z-axis is not greater than a height of the coil 40 in the Z-axis. The second portion 122 may be sheet-like or generally cuboid-like. The magnet 20 is stick-like and may be attached beneath the second portion 122 or partially or fully embedded within the second portion 122. In this embodiment, the second portion 122 is in the shape of a cuboid with a recess formed at a bottom thereof; the magnet 20 is embedded into the recess of the second portion 122 from below the second portion 122 and partially exposed; compared to a structure where the second portion 122 is sheet-like, an adhesion area between the magnet and the second portion is larger and the fixing strength is greater, and the magnet is also easy to be installed in place, facilitating the installation and limiting of the magnet. In addition, the second portion 122 and the magnet can be sized as thin as possible while securing the firmness of the fixation of the magnet. It will be understandable that poles of the magnet are in the X-axis direction, for example, the positive pole of the magnet is on the +X side, and the negative pole is on the −X side.

The support 30 serves to support and allow the shielding member 10 to move in a direction parallel to the X-axis, and is integrally made of a light plastic material. The support 30 may include a base plate and a plurality of linear springs or vertical springs suspending the shielding member 10 on the base plate; lower ends of the linear springs or vertical springs are fixed on the base plate, and upper ends of the linear springs or vertical springs are connected to the shielding sheet 11. The support 30 may also include a base plate and a plate spring mounted above the base plate, an inner side of the plate spring may be connected to the shielding sheet 11, and an outer side of the plate spring may be connected to the fixing portion erected on the base plate. The support 30 may also include a base plate and two elongated rails mounted on the base plate, both long sides of the shielding sheet 11 may be in contact with the rails.

In this embodiment, the support 30 is generally in a rectangular box shape with an upper opening and an inner space divided into two accommodating rooms 31 and 32 for accommodating the coil 40 and the locking assembly 50, respectively. Upper portions of two opposite side walls 33 of the support 30 form rails for supporting the shielding sheet 11, and the rails are capable of limiting a distance between the shielding sheet 11 and the coil 40 and of guiding the shielding sheet 11 to move in a direction parallel to the X-axis. To this end, the upper portions of the side walls 33 and 34 are provided with L-shaped steps arranged opposite to each other, and a plurality of arc-shaped protrusions 331 are preferably provided on the steps so as to reduce the contact area between the shielding sheet 11 and the support 30, thereby reducing the friction therebetween so that the shielding sheet 11 can slide more smoothly with less resistance. In addition, a width of the light shielding portion 114 of the shielding sheet 11 in the Y-axis direction is greater than the widths of other portions of the shielding sheet 11, so that only both sides of a lower surface of the light shielding portion 114 are in contact with the steps of the side wall 33, further reducing the contact area of the shielding sheet 11 with the support 30.

The coil 40 is fixed in the accommodating room 31 close to an end of the accommodating room 31. In order to prevent the shielding member 10 from moving toward a +Z-axis side, and at the same time to limit the movement position of the shielding member 10, a magnetic object, such as a magnetic conductive element 60 made of iron, cobalt, or nickel, is further provided between the coil 40 and a bottom of the accommodating room 31. In this embodiment, the magnetic conductive element 60 includes a substantially rectangular sheet-shaped substrate 61, and a limiting portion 62 and a second limiting portion 63 extending substantially perpendicularly from both ends of the substrate 61. The substrate 61 is substantially parallel to the plane defined by the X-axis and the Y-axis, with a length greater than a length of the coil 40 in the X-axis and is greater than or equal to a distance within which the light shielding portion 114 is preset to move. Thus, a magnetic attraction force with the substrate 61 is always kept during the movement of the magnet 20, which ensures the stability of movement.

Top ends of the limiting portions 62 and 63 should be located on the rails on which the magnet 20 moves and at two positions where the magnet 20 is preset to stay. Thus, the magnet 20 is subjected to a strong magnetic attraction force when approaching the limiting portions 62 and 63. In this embodiment, the coil 40 is disposed on the substrate 61 with an end thereof close to an end of the substrate 61 and the other end close to the middle of the substrate 61. The limiting portion 62 includes two opposing first and second flaps 621 and 622 extending substantially perpendicularly from the other end of the substrate 61. The first and second flaps 621 and 622 extend from both sides of the substrate, respectively; the current flowing through the coil is properly set so that the magnet 20 is stopped due to the magnetic attraction force and confined between the first flap 621 and the second flap 622 when the magnet 20 moves from the coil in a direction away from the coil to a position between the first flap 621 and the second flap 622 stop, in which case the light shielding portion 114 is defined to be in a so-called light shielded position (the shielding member is in a shielded position). The limiting portion 63 is a third flap extending substantially perpendicularly from an end of the substrate 61, and is opposed to an end of the coil 40. When moving from the limiting portion 62 to the inside of the coil, the magnet 20 is likely to be attracted by the limiting portion 63 to move toward the end of the coil 40, and finally stays at the limiting portion 63, in which case the light shielding portion 114 is defined to be in a so-called exposed position (the shielding member is in an exposed position), that is, a position where the light shield is absent.

Furthermore, a width (dimension in the Y-axis direction) of a portion of the substrate 61 close to the limiting portion 63 is smaller than a width of a portion of the substrate close to the limiting portion 62. That is, a width of a portion of the substrate 61 below the coil 40 is large, and a width of a portion not covered by the coil 40 is small. The arrangement is such that when the magnet moves in a direction from the limiting portion 63 to the limiting portion 62, the magnetic conductive element 60 is less attractive to the magnet 20 in a downward direction, so that the friction against the movement of the shielding member 10 is reduced and an increased speed of movement is possible.

In this embodiment, the magnetic conductive element 60 is fixed to the bottom of the accommodating room 31 by a fastener such as a screw. The coil 40 is adhered to an upper surface of the magnetic conductive element 60. A circuit board 42 electrically connected to the coil 40 is further fixed on an outer surface of the side wall 33 of the accommodating room 31, and a control circuit of the electronic apparatus can supply power to the coil 40 via the circuit board 42, thereby controlling the magnet 20 to move the shielding member 10 between the exposed position and the shielded position. Preferably, the magnet 20 is not in contact with the coil 40.

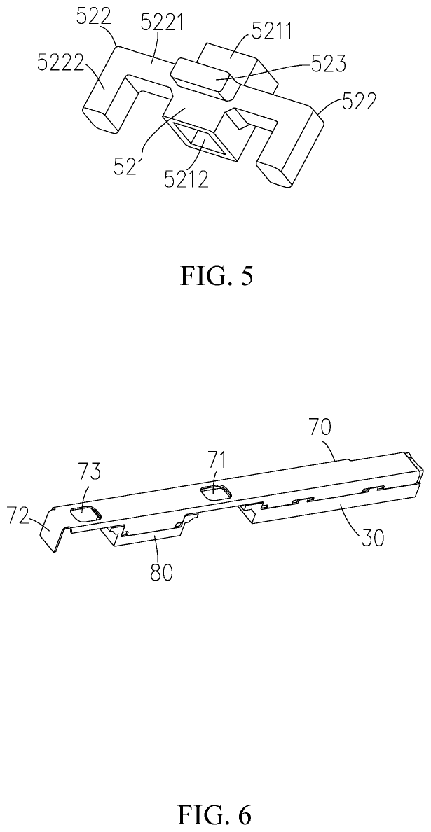

With reference to FIGS. 5 and 6, the locking assembly 50 serves to lock the shielding member 10 in the shielded position or the exposed position so that the locking assembly 50 can hold the shielding member 10 in place even if the electronic apparatus is suddenly moved at a high speed that may dislodge the shielding member 10 from the shielded position or the exposed position. In this embodiment, the locking assembly 50 mainly includes a second coil 51 wound in a hollow cylindrical shape, a second fixing block 52 provided between the second coil and the shielding sheet 11, a second magnet 53 fixed to the second fixing block 52, and a fixing sheet 54 provided between the shielding sheet 11 and the second fixing block 52.

Herein, a winding axis of the second coil 51 is parallel to the Z-axis and fixed at a position in the middle of the bottom of the accommodating room 32 of the support 30. The fixing sheet 54 is made of a magnetic substance, and as a magnetic conductive sheet of the locking assembly 50, is fixed at an opening of the accommodating room 32, that is, at upper portions of the two opposite side walls 33 of the support 30. A hole 541 is formed in the fixing sheet 54.

The second fixing block 52 serves as a locking portion of the locking assembly 50, and is integrally made of a light plastic material. The second fixing block 52 includes a cylindrical body 521 and two limiting arms 522 extended from an outer side wall of the body 521. An end of the body 521 serves as a locking pin 5211, and a hole 5212 for accommodating the second magnet 53 is formed on a surface of the other end. Because of the fixing sheet 54, when no current passes through the second coil 51, the second magnet 53 and the fixing sheet 54 are attracted to each other, and the locking pin 5211 extends out of the hole 541 of the fixing sheet 54 and is inserted into the hole 116 or 117 of the light shielding portion 114 to limit the shielding member 10 in the exposed position or the shielded position. When a current in a first predetermined direction flows through the second coil 51, a magnetic field generated thereby can drive the second magnet 53 to move on the inner side of the second coil 51 toward the −Z-axis side, thereby disengaging the locking pin 5211 from the hole 116 or 117, so that the coil 40 can drive the shielding member 10 to move. When a current in an opposite direction to the first predetermined direction flows through the second coil 51, a magnetic field generated thereby can drive the second magnet 53 to move on the inner side of the second coil 51 toward the +Z-axis side, so that the locking pin 5211 is inserted into the hole 116 or 117 again to lock the shielding member 10. It will be appreciated that when the magnetic field of the second magnet 53 is strong enough, or when the fixing sheet 54 is also a permanent magnet, the current in the opposite direction to the first predetermined direction may also be cancelled; when the supply of the current in the first predetermined direction to the second coil 51 is stopped, the second magnet 53 may cause the second fixing block 52 to automatically reset.

In this embodiment, a circuit board 55 electrically connected to the second coil 51 is further fixed on the outer surface of the side wall 33 of the accommodating room 32, and the control circuit of the electronic apparatus can supply power to the second coil 51 via the circuit board 55 to control the movement of the second magnet 53.

The limiting arm 522 serves to prevent the second fixing block 52 from rotating and tilting when the second fixing block 52 moves in the Z-axis direction. Specifically, in this embodiment, the limiting arm 522 is generally L-shaped with a first portion 5221 extending substantially perpendicularly from the outer side wall of the body 521 and a second portion 5222 extending from an end of the first portion 5221 toward the bottom of the accommodating room 32, i.e., toward the −Z-axis side. Accordingly, two limiting recesses 321 where the second portions 5222 of the limiting arms 522 are inserted are formed in the accommodating room 32.

In addition, the outer side wall of the body 521 further extends substantially perpendicularly to form a limiting boss 523, and an upper surface of the limiting boss 523 is substantially flush with an upper surface of the first portion 5221, so that when the second fixing block 52 moves to a highest position, that is, abutting against the fixing sheet 54, there are three positions where the second fixing block 52 contacts the fixing sheet 54, which is more stable.

To further prevent the shielding member 10 from disengaging the support 30, the shielding device of the present disclosure further includes a protective cover 70. The protective cover 70 is fixedly connected to the support 30, and they are not movable relative to each other, so as to clamp the shielding member 10 between the protective cover 70 and the support 30. The protective cover 70 is also integrally made of a light plastic material. In the electronic apparatus, the support 30 of the shielding device is placed alongside the photographing device, and a length of the protective cover 70 is greater than a length of the support 30. The protective cover 70 further covers the photographing device, and a through hole 71 for exposing the lens unit of the photographing device is formed at a position of the support 30 not covered by where the protective cover 70. A free end of the protective cover 70 further forms a bent portion 72 for enclosing the sides of the photographing device so that the photographing device and the shielding device are more closely connected. In the exposed position, the light shielding portion 114 of the shielding sheet 11 of the shielding member 10 does not extend out of an end of the support 30, so that the lens unit is exposed, and an image outside the electronic apparatus can be captured when the photographing device is activated. When the shielding member 10 is in the shielded position, the light shielding portion 114 protrudes out of the end of the support 30 to shield the lens unit, and at this time, even if the photographing device is activated, an image outside the electronic apparatus cannot be captured, and privacy is thus well protected.

In operation, to protect privacy, the shielding member 10 should be initially in the shielded position. When it is necessary to expose the lens unit of the photographing device so that it can take an image outside the electronic apparatus, an instruction may be sent to the circuit board 55 through the control circuit of the electronic apparatus, and the circuit board 55 supplies power to the second coil 51 so that the locking pin 5211 is disengaged from the hole 116; an instruction is then sent to the circuit board 42 so that the circuit board 42 supplies power to the coil 40 and the coil 40 drives the shielding member 10 to move to the exposed position; finally, an instruction is sent to the circuit board 55, and the circuit board 55 supplies a current in an opposite direction to the second coil 51 so that the locking pin 5211 is inserted into the hole 117 to lock the shielding member 10 in the exposed position. When it is necessary to return the shielding member 10 to the shielded position, firstly an instruction is sent to the circuit board 55 by the control circuit of the electronic apparatus, and the circuit board 55 supplies power to the second coil 51 so that the locking pin 5211 is disengaged from the hole 117; an instruction is then sent to the circuit board 42 so that the circuit board 42 supplies power to the coil 40 and the coil 40 drives the shielding member 10 to move to the shielded position; finally, an instruction is sent to the circuit board 55, and the circuit board 55 supplies a current in an opposite direction to the second coil 51 so that the locking pin 5211 is inserted into the hole 116 to lock the shielding member 10 in the shielded position.

### Second Embodiment

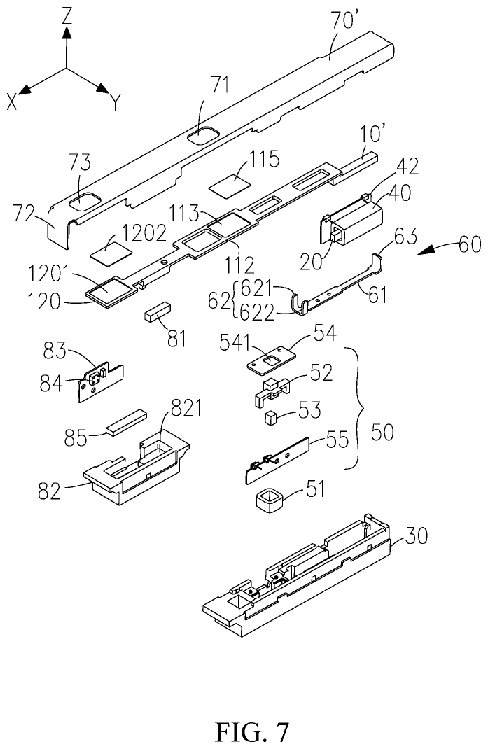

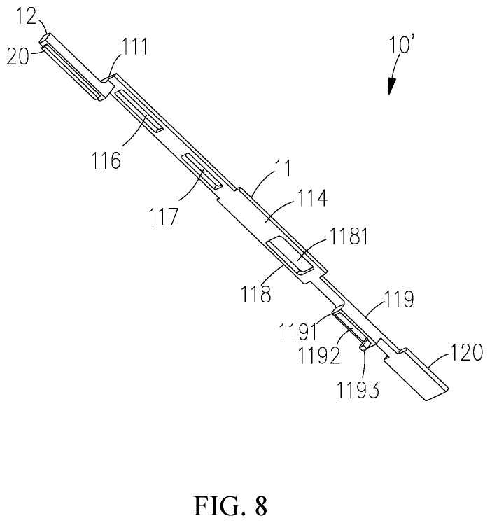

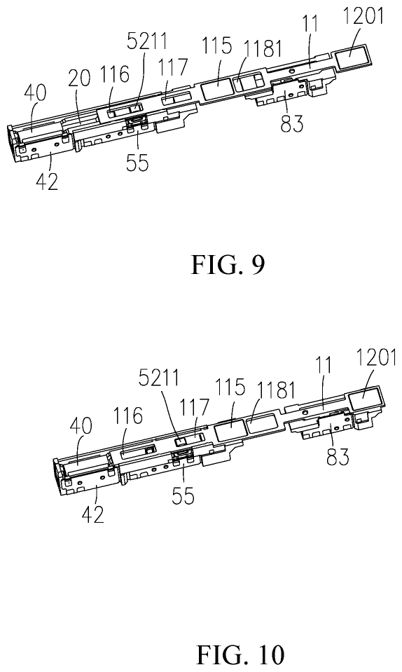

With reference to FIGS. 6 to 10, the shielding device of the electronic apparatus in a second embodiment has an additional position detection assembly 80 as compared with the shielding device in the first embodiment. The support 30, the locking assembly 50, the magnetic conductive element 60, the magnet 20, the coil 40, and the circuit board 42 in this embodiment are the same as those in the first embodiment, with the same reference numerals as those in the first embodiment. For the convenience of understanding, the same reference numerals as those in the first embodiment are used for the elements in the second embodiment, which are the same as those in the first embodiment.

As compared with the shielding member 10 of the first embodiment, the shielding member 10′ in this embodiment continues to extend in the +X-axis direction from the second end 112 to sequentially form an exposed portion 118 with an opening 1181, a third fixing portion 119 for fixing elements in the position detection assembly 80, and a third end 120 of the shielding member 10′. Herein, the photographing device of the electronic apparatus is fixed behind the exposed portion 118, and the lens unit faces the opening 1181 of the exposed portion 118. The third fixing portion 119 includes a projection 1191 extending from the shielding sheet 11 toward the −Z-axis side, a recess 1192 with an opening toward the −Z-axis side is formed in the projection 1191, and a column 1193 extends toward the −Z-axis side on the top of the projection 1191 close to an end of the projection. A recess 1201 for fixing an opaque or semi-transparent film or sheet 1202 is further formed on the side of the third end 120 facing the protective cover 70′.

Accordingly, the protective cover 70′ is also correspondingly elongated to cover the position detection assembly 80, specifically, a portion between the bent portion 72 and the through hole 71 is elongated. An opening 73 is further formed on the protective cover 70′ close to a distal end. When the shielding member 10′ is in the shielded position, the recess 1201 in which the opaque or semi-transparent film or sheet 1202 is fixed is opposite to the opening 73 so as to cover the opening 73, and a further photographing device is provided behind the opening 73, that is, the electronic apparatus of this embodiment has two photographing devices.

In this embodiment, the position detection assembly 80 for detecting the position of the shielding member 10′ includes a third magnet 81 fixed in the recess 1192 of the third fixing portion 119 of the shielding member 10′, a second support 82, a circuit board 83 fixed on the second support 82, and a Hall element 84 fixed on the circuit board 83. The second support 82 is in a box shape with an accommodating recess 821, and is preferably integrally made of a light plastic material. A gel 85 for shock absorption is provided in the accommodating recess 821. During movement of the shielding member 10′, a distal end of the column 1193 is always in contact with the gel 85, absorbing shock transmitted from the shielding member 10′, thereby reducing the noise of movement of the shielding member 10′.

The circuit board 83 is fixed to an inner or outer side wall of the second support 82, in this embodiment to the outer side wall.

In operation, when the shielding member 10′ is in the shielded position, the Hall element 84 is opposed to the third magnet 81 across the air, and when the shielding member 10′ is moved to the exposed position, the third magnet 81 is then moved to a position not directly opposite the Hall element 84. The control circuit of the electronic apparatus may determine the position of the shielding member 10′ according to changes in the magnetic field strength detected by the Hall element 84 to assist the on-off control of the shielding device. For example and without limitation, the position detection assembly 80 is taken to detect whether the shielding member 10′ reaches a preset position after each movement of the shielding member and before the locking assembly 50 locks, and only when the shielding member 10′ is detected to have reached the preset position can the locking assembly 50 be controlled to lock, which facilitates more accurate control of the product. In addition, the function of the shielding device can be verified by the position detection assembly 80, for example, the specific position of the shielding member 10′ is detected after controlling the shielding member 10′ to move and controlling the locking assembly 50 to lock, so as to judge whether the control of the movement of the shielding member 10′ is accurate, whether the locking assembly 50 can work normally, etc.

### Third Embodiment

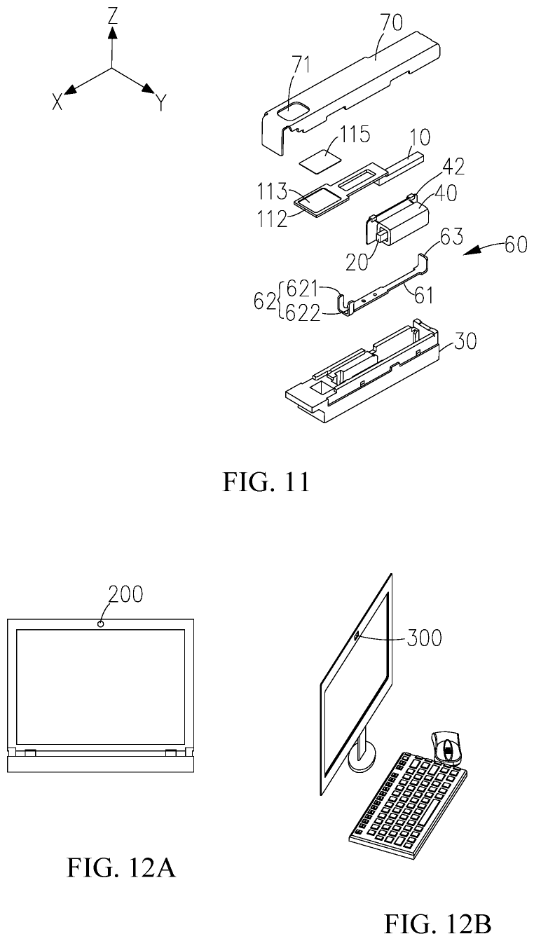

With reference to FIG. 11, this embodiment differs from the first embodiment in that a locking mechanism is eliminated. The shielding device in this embodiment is suitable for use on electronic apparatuses, such as laptop computers, desktop computers, and displays, that move infrequently or even frequently but are large in size (relative to smartphones).

### Fourth Embodiment

This embodiment has a structure similar to that of the second embodiment, in which the two photographing devices are separated by the position detection assembly 80; however, in the fourth embodiment, the two photographing devices are arranged close to each other or integrated so that the through holes 71 and 73 of the protective cover 70 are adjacently disposed or integrated into one rectangular through hole. Accordingly, the light shielding portion 114 and the exposed portion 118 of the shielding member 10′ may be longer and the third end 120 may be shorter.

### Fifth Embodiment

This embodiment is similar in structure to the second embodiment, and differs from the second embodiment in that the locking mechanism is eliminated.

In a variation of the above embodiments, the holes 116 and 117 in the shielding members 10 and 10′ may be replaced by recesses or notches.

In the above embodiments, the through holes 71 and 73 of the protective covers 70 and 70′ and the opening 1181 of the shielding members 10 and 10′ may also be replaced by notches running through the sides of the protective covers 70 and 70′ and the shielding members 10 and 10′.

In the above embodiments, the use of the magnetic conductive element 60 may restrict the movement of the shielding members 10 and 10′ in the Z-axis direction as well as in the X-axis direction. In other embodiments, the magnetic conductive element 60 may be omitted, because the shielding device of the present disclosure makes full use of the magnetic force generated by the four sides of the coil, and the magnet in combination with the coil can well drive the shielding member to move in the X-axis direction.

In the second and fourth embodiments described above, the gel 85 is provided in the accommodating recess 821 of the second support 82, and the shielding member 10′ is provided with the column 1193 that is inserted into the gel 85. In other embodiments, the gel and the column may be omitted.

In the description of the present disclosure, it is to be understood that terms like “first” and “second” are intended for illustrative purposes only and are not to be understood as expressing or implying relative importance or implicitly indicating the number of technical features indicated. Thus, a feature defined as “first” or “second” may explicitly or implicitly includes one or more of the feature. In the description of the present disclosure, the term “plurality” means two or more, unless specifically defined otherwise.

In the present disclosure, unless expressly stated or limited otherwise, terms like “mounted”, “coupled”, “connected”, and “fixed” are to be construed broadly. For example, a connection may be either fixed or detachable, or integral; a connection may be a mechanical connection or an electrical connection; a connection may be a direct connection or indirect connection through an intermediate medium, and may be the communication between two elements or interaction between two elements. The specific meaning of the above terms in the present disclosure can be understood by those skilled in the art according to specific circumstances.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A shielding device, comprising:
a shielding member;
a magnet fixed to the shielding member;
a support for supporting and allowing movement of the shielding member in a direction parallel to an X-axis; and
a coil wound in a hollow cylindrical shape with a winding axis parallel to the X-axis;
wherein at least a portion of the magnet is inserted into an inner side of the coil;
when currents in opposite directions flow through the coil, respectively, different magnetic fields are generated to drive the magnet to move along the winding axis in two opposite directions, respectively, thus making the shielding sheet move with the magnet.

2. The shielding device according to claim 1, wherein the shielding member comprises a shielding sheet and a fixing portion connected to the shielding sheet; the shielding sheet is an elongated sheet, and a plane defined by the shielding sheet is parallel to a plane defined by the X-axis and a Y-axis; the fixing portion comprises a first portion extending substantially perpendicularly from an end of the shield sheet, and a second portion extending from an end of the first portion in a direction parallel to the X-axis; the magnet is stick-like, fixed to the second portion.

3. The shielding device according to claim 1, further comprising a magnetic conductive element fixed below the coil; wherein at least a portion of the magnet is opposed to the magnetic conductive element across the coil, and the magnetic conductive element comprises:
a substantially rectangular sheet-like substrate parallel to the plane defined by the X-axis and the Y-axis and having a length greater than a length of the coil along the X-axis; and
a limiting portion extending substantially perpendicularly from an end of the substrate remote from the coil.

4. The shielding device according to claim 3, wherein the magnetic conductive element further comprises a second limiting portion extending substantially perpendicularly from another end of the substrate, the second limiting portion being substantially perpendicular to the X-axis and opposite to an end of the coil.

5. The shielding device according to claim 1, further comprising a locking assembly, the locking assembly comprising:
a second coil wound in a hollow cylindrical shape with a winding axis parallel to a Z axis and fixed below the shielding member;
a second fixing block provided between the second coil and the shielding sheet, an upper end of which forming a locking pin; and
a second magnet fixed at a lower end of the fixing block;
wherein at least two limiting recesses or limiting holes are defined on the shielding member,
when currents in opposite directions flow through the second coil, respectively, different magnetic fields are generated to drive the second magnet to move along the Z-axis in two opposite directions, respectively on the inner side of the second coil, thus making the second fixing block move with it, so that the locking pin is inserted into or pulled out from one of the at least two limiting recesses or limiting holes.

6. The shielding device according to claim 5, wherein the locking assembly further comprises a fixing sheet fixed between the shielding member and the second fixing block, the fixing sheet is provided with a hole in which the locking pin can be inserted, the fixing sheet is capable of being attracted by or acquiring the properties of a magnet.

7. The shielding device according to claim 5, wherein the second fixing block comprises a cylindrical body having an upper end as the locking pin and a lower end of which a surface where a hole for receiving the second magnet is provided; two limiting arms further extend from side walls of the body for preventing the second fixing block from rotating and tilting when the second fixing block is moved in a direction parallel with the Z-axis.

8. The shielding device according to claim 1, further comprising a position detection assembly, the position detection assembly comprising:
a third magnet fixed to the shielding member; and
a Hall element fixed adjacent to the support.

9. The shielding device according to claim 8, wherein the position detection assembly further comprises a circuit board configured for fixing the Hall element, and a second support configured for fixing the circuit board, the second support has an accommodating recess formed therein, the accommodating recess is provided with a shock-absorbing gel, a column extending from the shielding member toward the accommodating recess, at least an end of the column being in constant contact with the gel.

10. An electronic apparatus, comprising:
a photographing device comprising a lens unit; and
a shielding device;
wherein the shielding device comprises:
a shielding member;
a magnet fixed to the shielding member;
a support for supporting and allowing movement of the shielding member in a direction parallel to an X-axis; and
a coil wound in a hollow cylindrical shape with a winding axis parallel to the X-axis;
wherein at least a portion of the magnet is inserted into an inner side of the coil;
when currents in opposite directions flow through the coil, respectively, different magnetic fields are generated to drive the magnet to move along the winding axis in two opposite directions, respectively, thus making the shielding sheet move with the magnet to shield and expose the lens unit.

11. The electronic apparatus according to claim 10, wherein the shielding member comprises a shielding sheet and a fixing portion connected to the shielding sheet; the shielding sheet is an elongated sheet, and a plane defined by the shielding sheet is parallel to a plane defined by the X-axis and a Y-axis; the fixing portion comprises a first portion extending substantially perpendicularly from an end of the shield sheet, and a second portion extending from an end of the first portion in a direction parallel to the X-axis; the magnet is stick-like, fixed to the second portion.

12. The electronic apparatus according to claim 10, further comprising a magnetic conductive element fixed below the coil; wherein at least a portion of the magnet is opposed to the magnetic conductive element across the coil, and the magnetic conductive element comprises:
a substantially rectangular sheet-like substrate parallel to the plane defined by the X-axis and the Y-axis and having a length greater than a length of the coil along the X-axis; and
a limiting portion extending substantially perpendicularly from an end of the substrate remote from the coil.

13. The electronic apparatus according to claim 12, wherein the magnetic conductive element further comprises a second limiting portion extending substantially perpendicularly from another end of the substrate, the second limiting portion being substantially perpendicular to the X-axis and opposite to an end of the coil.

14. The electronic apparatus according to claim 10, further comprising a locking assembly, the locking assembly comprising:
a second coil wound in a hollow cylindrical shape with a winding axis parallel to a Z axis and fixed below the shielding member;
a second fixing block provided between the second coil and the shielding sheet, an upper end of which forming a locking pin; and
a second magnet fixed at a lower end of the fixing block;
wherein at least two limiting recesses or limiting holes are defined on the shielding member,
when currents in opposite directions flow through the second coil, respectively, different magnetic fields are generated to drive the second magnet to move along the Z-axis in two opposite directions, respectively on the inner side of the second coil, thus making the second fixing block move with it, so that the locking pin is inserted into or pulled out from one of the at least two limiting recesses or limiting holes.

15. The electronic apparatus according to claim 14, wherein the locking assembly further comprises a fixing sheet fixed between the shielding member and the second fixing block, the fixing sheet is provided with a hole in which the locking pin can be inserted, the fixing sheet is capable of being attracted by or acquiring the properties of a magnet.

16. The electronic apparatus according to claim 14, wherein the second fixing block comprises a cylindrical body having an upper end as the locking pin and a lower end of which a surface where a hole for receiving the second magnet is provided; two limiting arms further extend from side walls of the body for preventing the second fixing block from rotating and tilting when the second fixing block is moved in a direction parallel with the Z-axis.

17. The electronic apparatus according to claim 10, further comprising a position detection assembly, the position detection assembly comprising:
a third magnet fixed to the shielding member; and
a Hall element fixed adjacent to the support.

18. The electronic apparatus according to claim 17, wherein the position detection assembly further comprises a circuit board configured for fixing the Hall element, and a second support configured for fixing the circuit board, the second support has an accommodating recess formed therein, the accommodating recess is provided with a shock-absorbing gel, a column extending from the shielding member toward the accommodating recess, at least an end of the column being in constant contact with the gel.
